(19) United States
(12) Patent Application Publication
(10) Pub. No.: US 2021/0112803 A1
(43) Pub. Date: Apr. 22, 2021

(54) Shoe Mounted Weeding Assembly

(71) Applicant: Gary Hain, Hot Springs, AR (US)

(72) Inventor: Gary Hain, Hot Springs, AR (US)

(21) Appl. No.: 16/659,740

(22) Filed: Oct. 22, 2019

(51) Int. Cl. A01M 21/02

(52) U.S. Cl. CPC A01M 21/02

(57) ABSTRACT

A shoe mounted weeding assembly includes a bowl that is wearable on a toe of a shoe. In this way the bowl is can be manipulated by a user. A blade is coupled to and extends forwardly from the bowl. The blade is insertable into the ground when the bowl is worn on the shoe. In this way the blade can urge weeds from the ground without requiring a user to bend over. A first strap is coupled to the bowl and the first strap is extendable around a heel of the shoe for retaining the bowl on the shoe. A second strap is coupled to the bowl and the second strap is extendable around the heel of the shoe. Moreover, the second strap is matable to the first strap for retaining the bowl on the toe of the shoe.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to weeding devices and more particularly pertains to a new weeding device for removing weeds from the ground without hand tools.

### (2) Description of Related Art including Information Disclosed Under 37 CFR 1.97 and 1.98

The prior art relates to weeding devices.

### BRIEF SUMMARY OF THE INVENTION

An embodiment of the disclosure meets the needs presented above by generally comprising a bowl that is wearable on a toe of a shoe. In this way the bowl is can be manipulated by a user. A blade is coupled to and extends forwardly from the bowl. The blade is insertable into the ground when the bowl is worn on the shoe. In this way the blade can urge weeds from the ground without requiring a user to bend over. A first strap is coupled to the bowl and the first strap is extendable around a heel of the shoe for retaining the bowl on the shoe. A second strap is coupled to the bowl and the second strap is extendable around the heel of the shoe. Moreover, the second strap is matable to the first strap for retaining the bowl on the toe of the shoe.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a shoe mounted weeding assembly according to an embodiment of the disclosure.

FIG. 2 is a top view of an embodiment of the disclosure.

FIG. 3 is a right side view of an embodiment of the disclosure.

FIG. 4 is a bottom view of an embodiment of the disclosure.

FIG. 5 is a back view of an embodiment of the disclosure.

FIG. 6 is a perspective in-use view of an embodiment of the disclosure.

### DETAILED DESCRIPTION OF THE INVENTION

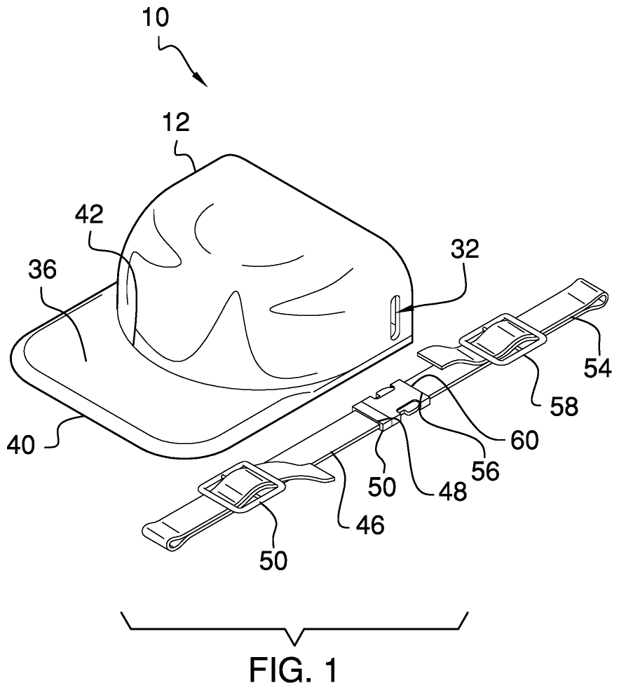

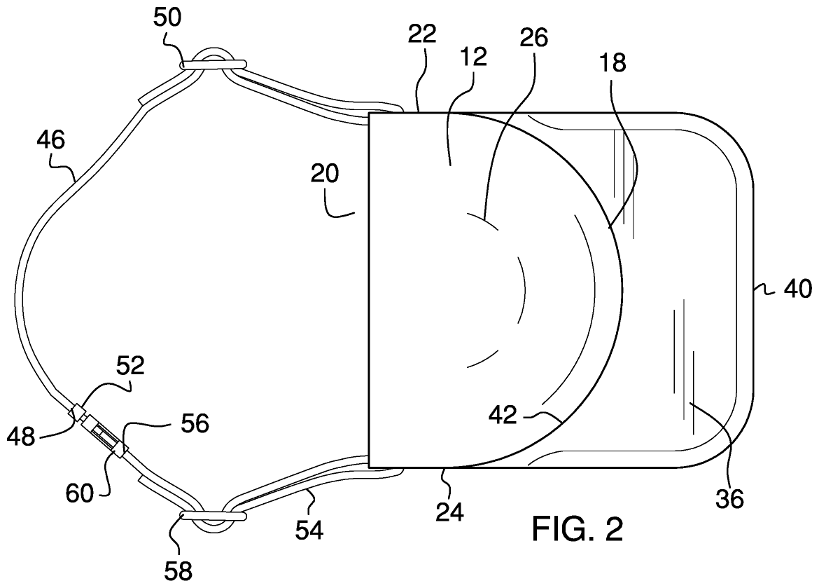

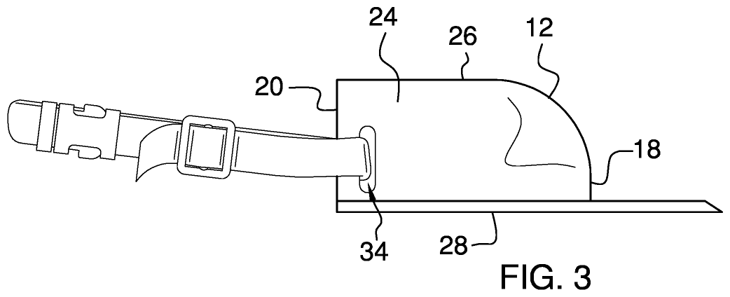

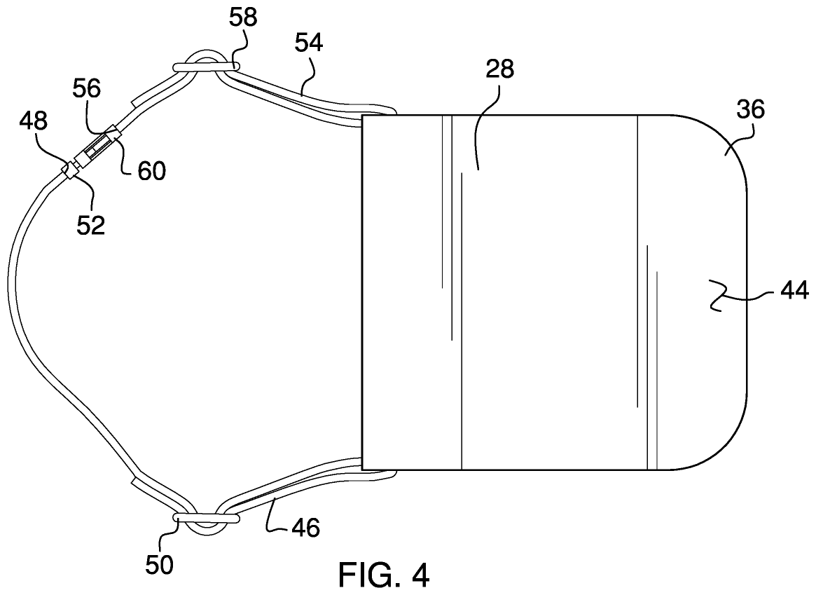

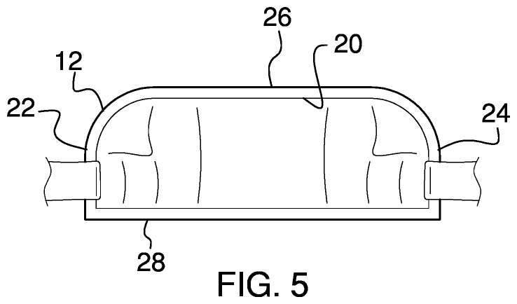

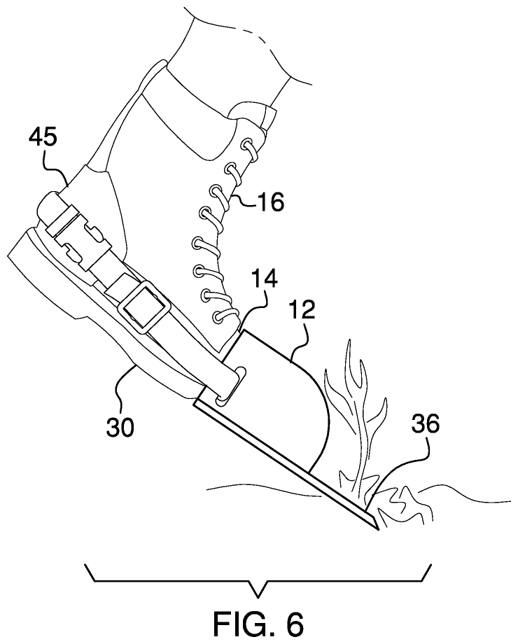

With reference now to the drawings, and in particular to FIGS. 1 through 6 thereof, a new weeding device embodying the principles and concepts of an embodiment of the disclosure and generally designated by the reference numeral 10 will be described.

As best illustrated in FIGS. 1 through 6, the shoe mounted weeding assembly 10 generally comprises a bowl 12 that is wearable on a toe 14 of a shoe 16 thereby facilitating the bowl 12 to be manipulated by a user. The shoe 16 may be a boot, a tennis shoe or any other type of shoe that the user is wearing. The bowl 12 has a front end 18, a back end 20, a first lateral side 22, a second lateral side 24, a top side 26 and a bottom side 28. The back end 20 is open for receiving the toe 14 of the shoe 16. The top side 26 curves downwardly at an intersection between each of the first lateral side 22 and the second lateral side 24.

The front end 18 is concavely arcuate with respect to the back end 20 for accommodating the toe 14 of the shoe 16. Additionally, the bottom side 28 is flattened and the sole 30 of the shoe 16 is positioned thereon when the shoe 16 is inserted into the bowl 12. The first lateral side 22 has a first slot 32 extending therethrough and the first slot 32 is positioned adjacent to the back end 20. The second lateral side 24 has a second slot 34 extending therethrough and the second slot 34 is positioned adjacent to the back end 20.

A blade 36 is coupled to and extends forwardly from the bowl 12. The blade 36 is insertable into the ground when the bowl 12 is worn on the shoe 16. Thus, the blade 36 can urge weeds 38 from the ground without requiring a user to bend over. In this way the user can remove weeds 38 from a yard or the like without using hand tools such as a hoe or other similar gardening tool. The blade 36 has a front edge 40, a back edge 42 and bottom surface 44 extending therebetween. The back edge 42 is coupled to the front end 18 of the bowl 12 and the back edge 42 conforms to curvature of the front end 18. Additionally, the bottom surface 44 lies on a plane that is coplanar with the bottom side 28 of the bowl 12. The front edge 40 of the blade 36 is sharpened to a point to enhance inserting the front edge 40 of the blade 36 into the ground.

A first strap 46 is coupled to the bowl 12 and the first strap 46 is extendable around a heel 45 of the shoe 16 for retaining the bowl 12 on the shoe 16. The first strap 46 is extendable through the first slot 32 and the first strap 46 has a distal end 48 with respect to the bowl 12. A first adjuster 50 is provided and the first strap 46 is extendable therethrough for adjusting a length of the first strap 46. A first mating member 52 is coupled to the distal end 48 of the first strap 46. The first mating member 52 may comprise a male buckle or other type of releasable fastener.

A second strap 54 is coupled to the bowl 12 and the second strap 54 is extendable around the heel 45 of the shoe 16. Additionally, the second strap 54 is matable to the first strap 46 for retaining the bowl 12 on the toe 14 of the shoe 16. The second strap 54 is extendable through the second slot 34 and the second strap 54 has a distal end 56 with respect to the bowl 12. A second adjuster 58 is provided and the second strap 54 is extendable therethrough for adjusting a length of the second strap 54. A second mating member 60 is coupled to the distal end 56 of the second strap 54 and the second mating member 60 releasably engages the first mating member 52.

In use, the toe 14 of the shoe 16 is inserted in the bowl 12 and each of the first strap 46 and the second strap 54 are secured around the heel 45 of the shoe 16. The blade 36 is urged into the ground next to a weed 38 and the user steps downwardly on the heel 45 of the shoe 16. Thus, the blade 36 lifts the weed 38 out of the ground without requiring the user to bend over. In this way weeds 38 can be removed from a yard or the like without requiring the user to employ hand tools.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A shoe mounted weeding assembly being configured to be mounted to a shoe for removing weeds from the ground, said assembly comprising:
a bowl being wearable on a toe of a shoe wherein said bowl is configured to be manipulated by a user;
a blade being coupled to and extending forwardly from said bowl, said blade being insertable into the ground when said bowl is worn on the shoe wherein said blade is configured to urge weeds from the ground without requiring a user to bend over;
a first strap being coupled to said bowl, said first strap being extendable around a heel of the shoe for retaining said bowl on the shoe; and
a second strap being coupled to said bowl, said second strap being extendable around the heel of the shoe, said second strap being matable to said first strap for retaining said bowl on the toe of the shoe.

2. The assembly according to claim 1, wherein said bowl has a front end, a back end, a first lateral side, a second lateral side, a top side and a bottom side, said back end being open for receiving the toe of the shoe, said top side being curving downwardly at an intersection between each of said first lateral side and said second lateral side, said front end being concavely arcuate with respect to said back end for accommodating the toe of the shoe, said bottom side being flattened for having a sole of the shoe being positioned thereon when the shoe is inserted into said bowl.

3. The assembly according to claim 2, wherein:
said first lateral side has a first slot extending therethrough, said first slot being positioned adjacent to said back end; and
said second lateral side has a second slot extending therethrough, said second slot being positioned adjacent to said back end.

4. The assembly according to claim 3, wherein said first strap is extendable through said first slot, said first strap having a distal end with respect to said bowl.

5. The assembly according to claim 4, further comprising a first adjuster having said first strap being extendable therethrough for adjusting a length of said first strap.

6. The assembly according to claim 5, further comprising a first mating member being coupled to said distal end of said first strap.

7. The assembly according to claim 7, wherein said second strap is extendable through said second slot, said second strap having a distal end with respect to said bowl.

8. The assembly according to claim 7, further comprising a second adjuster having said second strap being extendable therethrough for adjusting a length of said second strap.

9. The assembly according to claim 8, further comprising a second mating member being coupled to said distal end of said second strap, said second mating member releasably engaging said first mating member.

10. A shoe mounted weeding assembly being configured to be mounted to a shoe for removing weeds from the ground, said assembly comprising:
a bowl being wearable on a toe of a shoe wherein said bowl is configured to be manipulated by a user, said bowl having a front end, a back end, a first lateral side, a second lateral side, a top side and a bottom side, said back end being open for receiving the toe of the shoe, said top side being curving downwardly at an intersection between each of said first lateral side and said second lateral side, said front end being concavely arcuate with respect to said back end for accommodating the toe of the shoe, said bottom side being flattened for having a sole of the shoe being positioned thereon when the shoe is inserted into said bowl, said first lateral side having a first slot extending therethrough, said first slot being positioned adjacent to said back end, said second lateral side having a second slot extending therethrough, said second slot being positioned adjacent to said back end;
a blade being coupled to and extending forwardly from said bowl, said blade being insertable into the ground when said bowl is worn on the shoe wherein said blade is configured to urge weeds from the ground without requiring a user to bend over, said blade having a front edge, a back edge and bottom surface extending therebetween, said back edge being coupled to said front end of said bowl, said back edge conforming to curvature of said front end, said bottom surface lying on a plane being coplanar with said bottom side of said bowl;
a first strap being coupled to said bowl, said first strap being extendable around a heel of the shoe for retaining said bowl on the shoe, said first strap being extendable through said first slot, said first strap having a distal end with respect to said bowl;
a first adjuster having said first strap being extendable therethrough for adjusting a length of said first strap;
a first mating member being coupled to said distal end of said first strap;
a second strap being coupled to said bowl, said second strap being extendable around the heel of the shoe, said second strap being matable to said first strap for retaining said bowl on the toe of the shoe, said second strap being extendable through said second slot, said second strap having a distal end with respect to said bowl;
a second adjuster having said second strap being extendable therethrough for adjusting a length of said second strap; and
a second mating member being coupled to said distal end of said second strap, said second mating member releasably engaging said first mating member.
